(19) United States
(12) Patent Application Publication
(10) Pub. No.: US 2002/0066841 A1
(43) Pub. Date: Jun. 6, 2002

(54) Plastic retainer

(76) Inventors: Yasutaka Nishida, Macon, GA (US); John J. Valdes, Macon, GA (US)

Correspondence Address: Terry W. Kramer, Esq., Kramer & Associates, Suite 1101, 2001 Jeff. Davis Hwy., Arlington, VA, 22202, US

(21) Appl. No.: 09/985,378

(22) Filed: Nov. 2, 2001

Related U.S. Application Data
(60) Provisional application No. 60/250,451, filed on Dec. 1, 2000.

(51) Int. Cl. F16B 1/00; E04G 3/00; G09F 7/18; A47B 96/06

(52) U.S. Cl. 248/229.16; 248/214; 248/227.2

(57) ABSTRACT

A flexible retainer for securing a web-like material, such as a table skirt, to a flat surface or table. The retainer has a frontwardly extending upper member, a substantially U-shaped lower member having a frontwardly extending first leg, and a primary member connecting the upper member to the lower member. The structure of the retainer and the configuration of its elements help to mask its appearance when used to retain a table skirt. In addition, extending into the lower end of the primary member are one or more vertical slots, which define one or more fingers. The configuration of the slots serve to improve the flexibility of the retainer, while maintaining the primary member's surface area for disposition of fasteners.

### BACKGROUND OF THE INVENTION

1. Field of the Invention

The present invention relates to a retainer for detachably securing a web-like material, such as a table skirt to a flat surface or table. More particularly, the invention relates to a flexible retainer capable of being attached to table top edges, wherein a table skirt is secured to the retainer using hook and loop fasteners.

This application claims the benefit of U.S. Provisional Application No. 60/250,451 entitled “PLASTIC RETAINER,” filed on Dec. 1, 2000.

2. Description of the Prior Art

Table skirts are commonly placed around the periphery of various types of tables in order to improve the appearance of the tables. The table skirts must be attached to the tables in such a manner that they resist falling or shifting when exposed to various conditions, such as wind or frequent contact by people. On the other hand, it often becomes necessary to remove a table skirt from a table for cleaning or pressing when the table skirt becomes soiled or wrinkled. As such, various fastening devices have been employed to hold the table skirts in place during use and also to allow easy removal of the table skirts from the tables.

Conventionally, a table skirt is attached to a table top using snap buttons. The male components of the snap buttons are sewn to a strip of material that is secured to the table edge by, e.g., an adhesive. The female components of the snap buttons are sewn along an edge of the table skirt. The female components may then be snapped into the male components to retain the table skirt around the table edge. The table skirt may be detached from the table edge by simply unsnapping the buttons. Unfortunately, attachment of the table skirt to the table top using such buttons may be time consuming since each button must be snapped on individually.

More recently, plastic retainers have been used to hold table skirts around the periphery of table tops. FIG. 1 depicts one prior art type of plastic retainer 110, which includes a planar primary member 120, an upper member 140 and a lower member 160. Primary member 120 is typically square or rectangular in shape, and includes a hook portion 180, of a hook and loop type fastener, on its back surface. This hook portion may be extruded as part of the manufacture of the retainer or may be attached, such as through adhesion.

Still referring to FIG. 1, the prior art retainer is typically attached to the edge of a table top by engaging the upper surface of the table top with upper member 140, and by engaging the lower surface of the table top with lower member 160. A common flaw with this type of retainer is the manner in which it engages a flat surface, such as a table. As the lower member is biased against the edge of the flat surface, the leg deforms. In order to maintain the retainer in place upper member 140 exerts pressure against one side of the flat surface, while the lower member 160 exerts pressure to the opposite side of the flat surface. Due to the design of the prior art retainers, this pressure is not evenly distributed, and the retainers have a tendency to disengage, through slippage, from the flat surface. The lack of proper pressure distribution is due to the upper member 140 not having its flat surface engaging portion directly above the lower member's 160 flat surface engaging portion. The predetermined spacing d₁₀ of the prior art determines to which sized tables retainer 110 may be attached. The predetermined spacing is most commonly ¾ inch or ⅜ inch and pertains to the height of the edge of the table top. After the prior art retainer is secured to a table top in this manner, hook portion 180 remains exposed so that a loop portion (not shown) attached to a table skirt (also not shown) may engage hook portion 180. Generally, a plurality of retainers are secured around one or more sides of the table top, and then the table skirt is attached to the plurality of retainers. The table skirt may be removed from the table top by separating the hooks and loops.

Upper member 140 of the prior art retainer typically extends perpendicularly from primary member 120. Lower member 160 extends from the lower end of the primary member. Still referring to FIG. 1, first leg 162 of the lower member is typically much shorter than second leg 164, and typically slants away from the table, and toward the table skirt, when the retainer is engaged with a table. Thus, a skirt using the prior art retainer does not lay flat along a vertical plane. This can result in an undesired appearance of the table skirt and/or a “bunching up” of the table skirt due to the outward slant of the lower member. Finally, the conventional prior art plastic retainers are relatively rigid, while there is a need for flexibility to easily secure the retainer to, and remove the retainer from, the table top edge. In particular, primary member 120 typically consists of a unitary (fingerless and notchless) rectangular piece of plastic, and therefore, is relatively rigid. Moreover, leg 162, being short relative to leg 164, further contributes to the retainer's rigidity.

Guebert et al., U.S. Pat. No. 4,237,958, disclose a draper connector assembly. Guebert et al. show a retainer protruding backwardly (away from the plane of the primary member in a direction opposite the upper member). Furthermore, Guebert et al. disclose a primary member without any hook mountable flexibility-contributing fingers and, therefore, does not teach the invention as claimed.

Ehrlich, U.S. Pat. No. 5,060,712, discloses a table skirt-attaching method. Ehrlich shows a notchless and fingerless (albeit perforated) rectangular, vertically-oriented primary member that is relatively rigid, and that would necessarily bow (or spring) outward upon engagement of the retainer with a table edge. Thus, Ehrlich does not teach the invention as claimed.

### SUMMARY OF THE INVENTION

Accordingly, the present invention is directed to a flexible retainer for detachably securing a web-like material, such as a table skirt to a flat surface or table, where the retainer substantially obviates one or more of the problems that are due to the limitations and disadvantages of the related art described above.

The retainer comprises a primary member having an upper end, a lower end, a front surface and a back surface. The retainer further comprises an upper member that extends from the upper end of the front surface of the primary member. The retainer further comprises a lower member that extends from the lower end of the primary member. The lower member is substantially U-shaped having first and second legs. The first leg extends downward, and away from the major plane of the primary member in the same direction as the upper member—that is, frontwardly. The retainer is attachable to the edge of a table top by engaging an upper surface of the table top with the upper member and a lower surface of the table top with the lower member.

Extending upward from the lower end of the primary member are a plurality of slots, which define outside fingers of the primary member. Preferably, there are two slots, and therefore two fingers. The distance between these slots define the width of the lower member. The purpose of these slots is to improve the flexibility of the retainer, while maintaining the primary member's surface area for disposition of the hook fasteners. Further contributing to the flexibility of the retainer, first and second legs of the lower member are substantially equal in length. In the preferred embodiment, there is a hook portion positioned on the back surface of the primary member that is capable of engaging a loop portion positioned on a table skirt. The hook portion comprises a plurality of hook patches, preferably integral with the primary member. The upper member may comprise a variety of shapes, including substantially triangular or substantially bell-shaped. The retainer is preferably made from a substantially transparent plastic, such as polyolefin, polycarbonate, nylon or the like.

The first leg necessarily extends frontwardly (towards the table), in either a slant or in a serpentine, S-shaped bend—which serves as a convenient axis of rotation for the lower member as the retainer is biased into or out of engagement with a table edge, whereas the frontward extension eliminates any protrusion of the retainer through the vertical plane of the table skirt.

The present invention is further directed towards a method of securing web-like materials, such as skirting, to a flat surface, such as the edge of a table top. The retainers comprise a primary member with an upper end, a lower end, a front surface facing frontwardly, a back surface opposite the front surface, and a hook portion of a hook and loop type fastener formed on the back surface. The retainer further includes a frontwardly extending upper member, a substantially U-shaped lower member having a first leg extending frontwardly from the lower end, and a second leg extending from the first leg. A plurality of the retainers are then attached to the edges of a flat surface, such as a table top, by engaging the upper surface of the flat surface with the upper member, and by engaging the lower surface of the flat surface with the lower member. The hook portion of the retainer is then engaged by the loop portion of the web-like material, thereby providing skirting to flat surfaces, such as tables.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention and are incorporated as part of this specification. The drawings illustrate two embodiments of the invention and, together with the description, serve to explain the principles of the invention.

FIG. 1 is a side elevation view of a prior art retainer for securing a table skirt to a table top;

FIG. 2 is a front perspective view of one embodiment of a retainer of the present invention;

FIG. 3 is a rear perspective view of the retainer of FIG. 2;

FIG. 4 is a side elevation view of the retainer of FIG. 2;

FIG. 5 is a front elevation view of the retainer of FIG. 2;

FIG. 6 is a side view of the retainer of FIG. 2;

FIG. 7 is a top plan view of the retainer of FIG. 2;

FIG. 8 is a bottom plan view of the retainer of FIG. 2;

FIG. 9 is a front perspective view of a 2nd embodiment of the present invention;

FIG. 10 is a rear perspective view of the retainer of FIG. 9;

FIG. 11 is a rear elevation view of the retainer of FIG. 9;

FIG. 12 is a front elevation view of the retainer of FIG. 9;

FIG. 13 is a side elevation view of the retainer of FIG. 9;

FIG. 14 is a top plan view of the retainer of FIG. 9; and

FIG. 15 is a bottom plan view of the retainer of FIG. 9.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers will be used throughout the drawings to refer to the same or like parts.

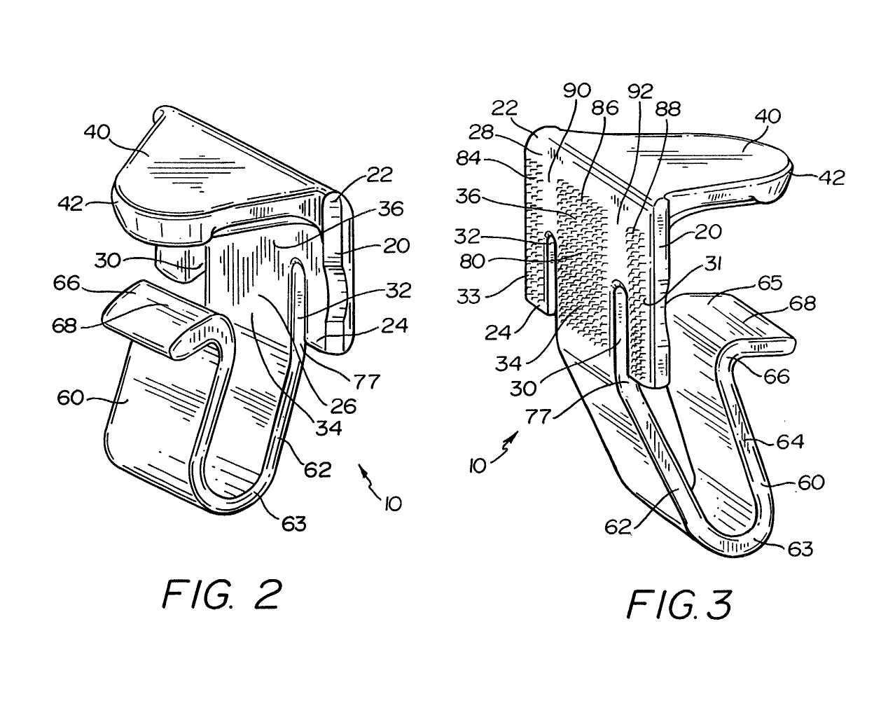

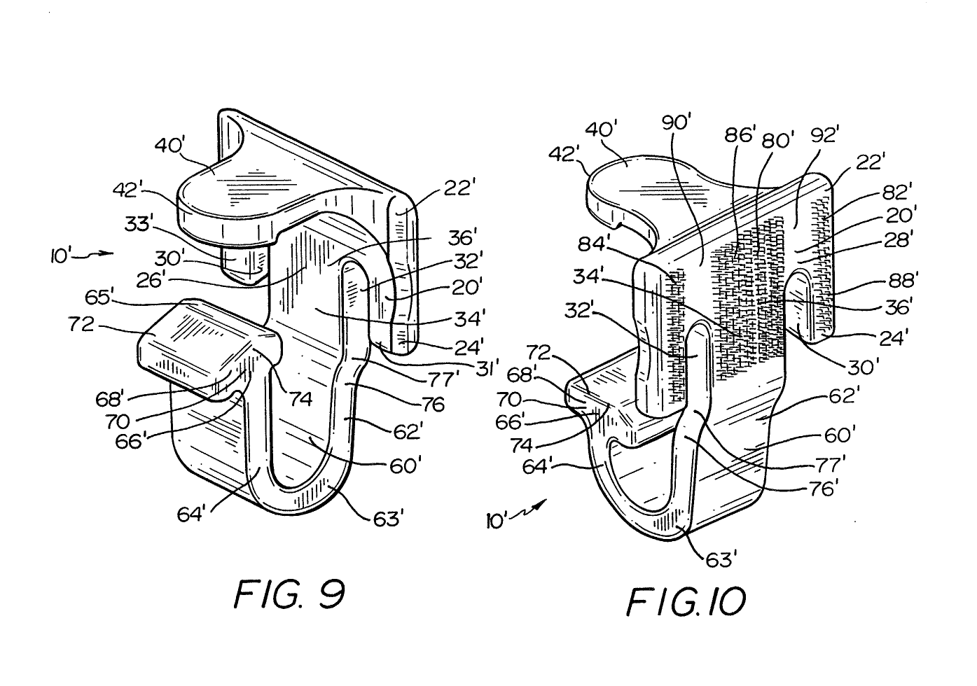

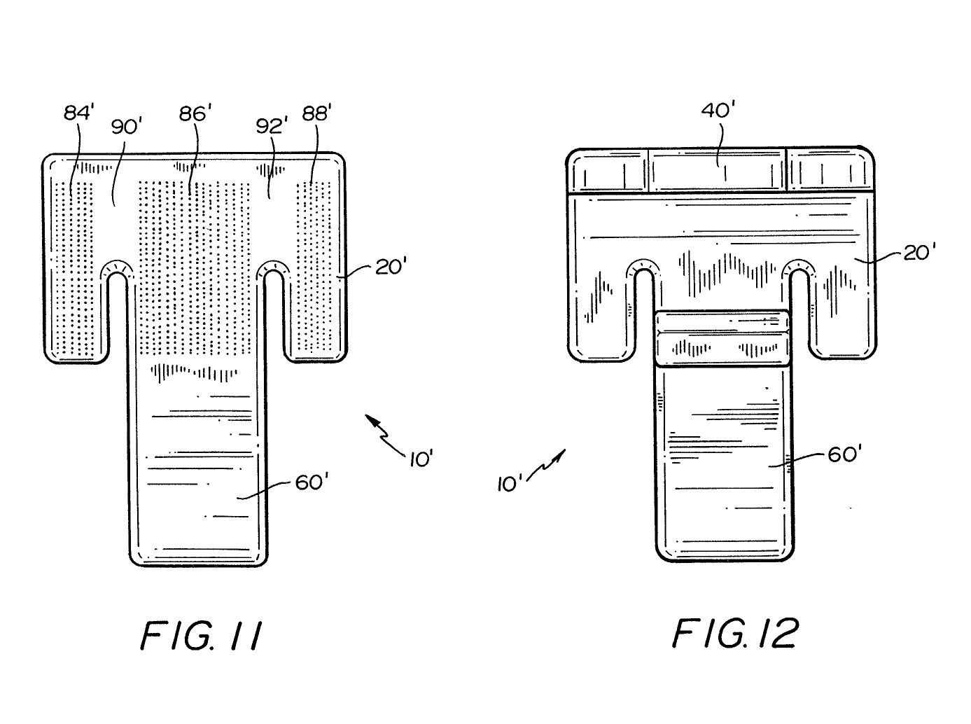

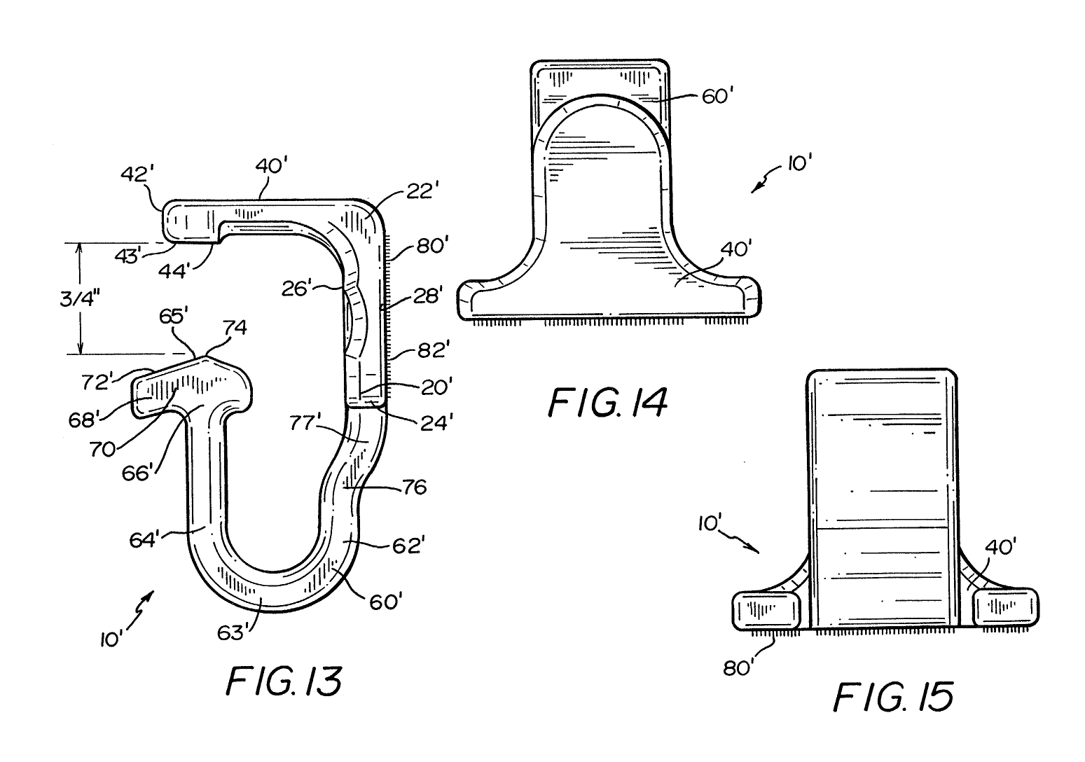

FIGS. 2 through 8 illustrate one embodiment of a retainer of the present invention, while FIGS. 9 through 15 illustrate another embodiment of a retainer of the present invention. The different embodiments are directed to retainers for detachably securing web-like materials, such as table skirts, and having slightly different structural features serving slightly different purposes. In particular, FIGS. 2 through 8 are directed to a table top having an edge with a height of about ⅜ inch, while FIGS. 9 through 15 are directed to a table top having an edge with a height of about ¾ inch. The present invention, however, is not limited to these particular table sizes, and may comprise various dimensions to fit other size heights of table top edges.

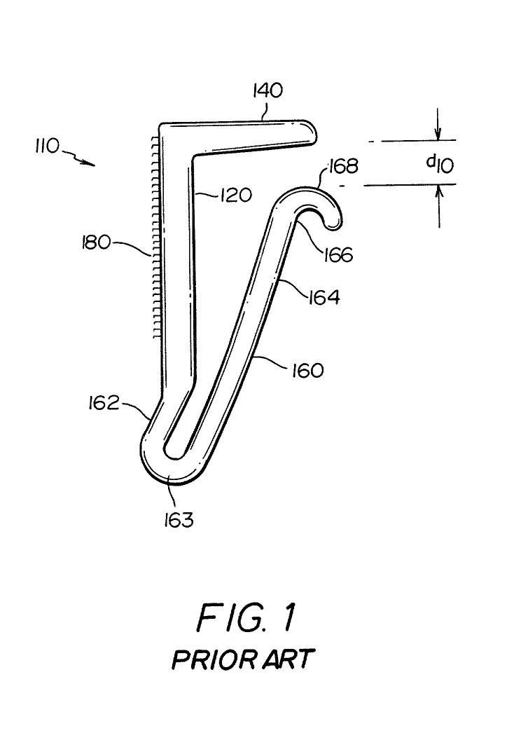

As shown in FIGS. 2 through 15, the retainer of the present invention is somewhat similar in shape to conventional retainers (see FIG. 1). However, the retainer of the present invention includes certain features to overcome the disadvantages and limitations of conventional retainers. As shown in FIGS. 2 through 8, retainer 10 of the present invention includes a primary planar member 20, an upper member 40, and a lower member 60. The primary member 20 is substantially square or rectangular in shape, and has an upper end 22, a lower end 24, a front surface 26 and a back surface 28. The terms “upper,” “lower,” “front,” and “back” are relative to the table top to which a retainer is secured. Thus, when retainer 10 is secured to the table top, upper end 22 is positioned above lower end 24, front surface 26 faces toward the table top, and back surface 28 faces the direction opposite front surface 26, i.e., towards the table skirt. Primary member 20 also includes two substantially identical slots 30, 32, which extend upward from lower end 24. Slots 30, 32 define a section 34 of primary member 20 from which lower member 60 extends downward.

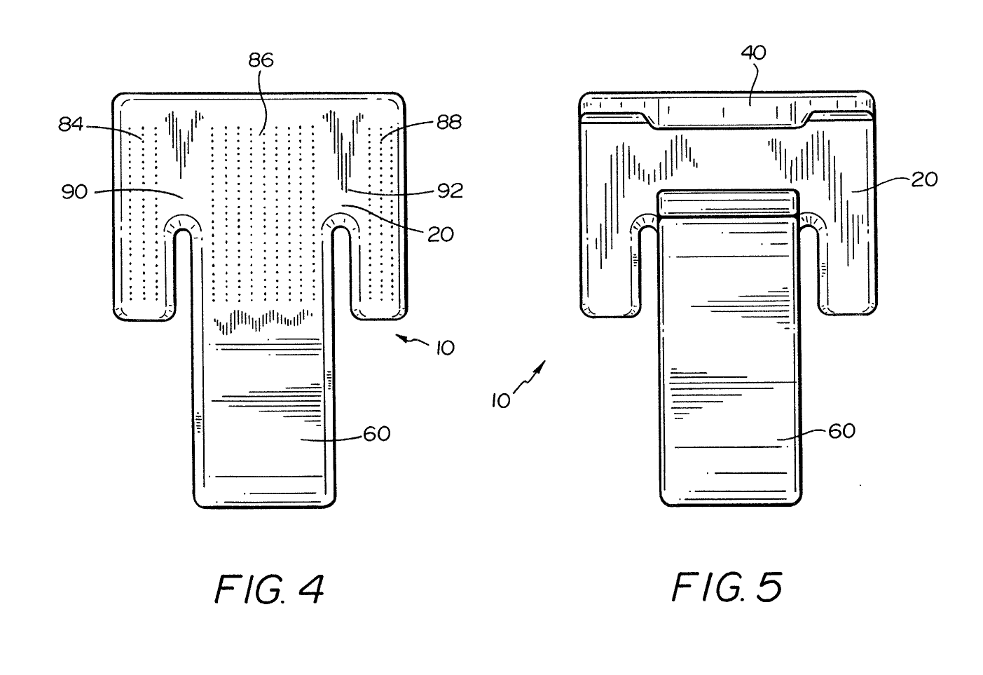

A hook portion 80 is positioned on back surface 28 of primary member 20. Hook portion 80 preferably includes a plurality of hooks 82 of the hook and loop type fastener. Hooks 82 are generally positioned over a substantial portion of the area of back surface 28 of primary member 20. In one embodiment, as shown in FIGS. 3 and 4, hooks 82 are positioned in three separate hook areas 84, 86, and 88, with two hook-free areas 90, 92. In particular, hook-free area 90 is positioned between the hook areas 84 and 86, while hook-free area 92 is positioned between hook areas 86 and 88.

Upper member 40 of retainer 10 extends perpendicularly from primary member 20 at or near upper end 22 of primary member 20, and is substantially horizontal. Upper member 40 extends outward from front surface 26 of primary member 20, in the direction toward the table top (not shown) when retainer 10 is secured to a table top. Upper member 40 may comprise a wide variety of shapes and sizes, including, but not limited to, circular, half-circular, triangular, substantially triangular, bell-shaped, and the like. In the embodiment shown in FIGS. 2 through 8, upper member 40 is substantially triangular in shape, with a rounded front edge 42.

As shown in FIGS. 2, 3 and 6, lower member 60 is substantially U-shaped, beginning from section 34, at the lower end of primary member 20. The substantially U-shaped lower member 60 is comprised of a first leg 62 extending downward from section 34, and a second leg 64 extending from leg 62 upward toward upper member 40. First leg 62 slants downward from primary member 20, and frontwardly, meaning in the same direction from the major plane of primary member 20 that upper member 40 extends, or more plainly, towards the table.

Upper end 66 of leg 64 of lower member 60 is spaced a distance below upper member 40. In use, the retainer 10 is attached to the edge of a table top (not shown) by engaging the upper surface of the table top with upper member 40 and the lower surface of the table top with lower member 60. More particularly, the upper surface of the table top engages with the lower surface 44 of upper member 40, and the lower surface of the table top engages with upper end 66 of leg 64 of the lower member.

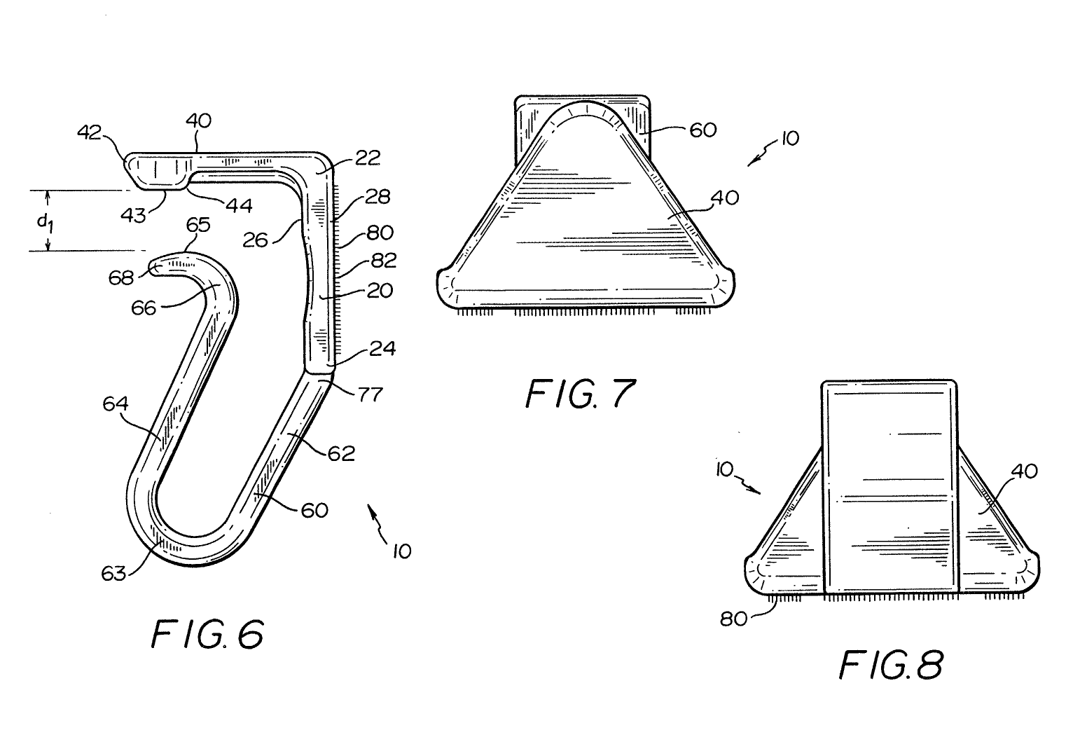

Upper end 66 of leg 64 preferably includes a chamfered portion 68 to help engage it with the lower surface of a table top. As shown in FIGS. 2, 3 and 6, in one embodiment, portion 68 is curved or arc-shaped. Portion 68 is not limited to being curved, but may comprise any shape and size that aids in engaging the lower surface of a table top. As shown in FIG. 6, portion 68 is generally positioned directly beneath front edge 42 of upper member 40. Preferably, portion 68 does not extend beyond front edge 42. In addition, preferably, an engagement surface 43 on upper member 40 is positioned directly below an engagement surface 65 on lower member 60. This arrangement allows for the even distribution of pressure to the engagement surfaces, thereby preventing disengagement through slippage.

The distance d₁ between the upper surface of portion 68 and the lower surface of upper member 40 determines the particular table top to which a retainer may be secured. In particular, in the embodiment shown in FIGS. 2 through 8, the distance d₁ is about ⅜ inch and, thus, as stated above, retainer 10 may be secured to those tables having a table top with an edge height of about ⅜ inch.

As shown most clearly in FIGS. 2, 3 and 6, legs 62 and 64 of lower member 60 are substantially the same length when measuring leg 62 from lower end 24 of primary member 20 to juncture 63 (bottom point) of legs 62 and 64, and when measuring leg 64 from juncture 63 of legs 62 and 64 to curved portion 68. In particular, legs 62, 64 may be about 13 mm to about 30 mm in length. Legs 62 and 64 may also be a length of about 25.5 mm.

While legs 62 and 64 are preferably substantially the same length, leg 62 of the present invention is relatively long in comparison to conventional retainers. In addition, primary member 20 is preferably shorter in length (i.e., from lower end 24 to upper end 22) than conventional retainers. Because the length of leg 62 in the present invention is extended, the distance between lower end 24 of primary member 20 and the bottom of the U-shape of lower member 60 (i.e., juncture 63) is also greater. This greater distance results in greater flexibility for the retainer of the present invention. As stated above, the retainer must be sufficiently flexible in order to easily secure the retainer to a table top edge and to easily remove the retainer from the table top edge. Primary member 20, as a square or rectangular member typically made of a plastic material, is otherwise rigid and relatively inflexible. Thus, the greater the relative length of leg 62, the more flexible is retainer 10.

In addition, the flexibility of retainer 10 of the present invention is enhanced because of the presence of two, preferably continuous slots 30 and 32 formed through primary member 20. However, there could just as easily be one continuous slot. In particular, slots 30 and 32 define finger 31 and finger 33 of primary member 20. Slots 30 and 32 are continuous from the interior of primary member 20 to a lower edge of primary member 20 so as to define the side edges of leg 62. Fingers 31 and 33 generally correspond to hook areas 88 and 84, respectively. Fingers 31 and 33 are useful because they enable primary member 20 to have a larger surface area for attachment of hook areas 88 and 84, while providing retainer 20 with the same flexibility that a retainer would have if fingers 31 and 33 were severed at their upper end and removed. Moreover, leg 62 angles downward from primary member 20 in the direction towards the table top, and not towards the table skirt. This angle or slant of leg 62 is such that a table skirt secured to retainer 10 may lay flat in the downward direction, and will not slant outward from the table, as may occur with the conventional retainers previously discussed. Note that even a perfectly vertical primary member will still slant outward when the retainer is biased when capturing the edge of a table top.

The flexibility of lower member 60 is enhanced because of two radius portions present in lower member 60. The first radius portion 77 is formed at the intersection of lower member 60 and primary member 40. The second radius portion is at juncture 63.

FIGS. 9 through 15 illustrate an alternative embodiment of the retainer of the present invention. This retainer is for securing to those table tops having an edge with a height of about ¾ inch. The retainer 10′ shown in FIGS. 9 through 15 is similar to retainer 10 shown in FIGS. 2 through 8. In particular, retainer 10′ includes a primary member 20′, an upper member 40′, a lower member 60' and a hook portion 80′.

Primary member 20′ includes an upper end 22′, a lower end 24′, a front surface 26′ and a back surface 28′, along with slots 30′, 32′ that extend upward from the lower end 24′. Slots 30′, 32′ define a section 34′ of primary member 20′ from which lower member 60′ extends. In addition, a hook portion 80′ is positioned over substantially the entire back surface 28′ of primary member 20′. Hook portion 80′ includes a plurality of hooks 82′ for engagement with loops of a hook and loop type fastener that are positioned on a table skirt. Preferably, hooks 82′ comprise three hook areas 84′, 86′ and 88′, with hook-free areas 90′, 92′ there between.

Upper member 40′ extends frontwardly, as previously defined, from upper end 22′, and is preferably perpendicular to the major plane of primary member 20′ when retainer 10′ is secured to the table. In this embodiment, as shown most clearly in FIGS. 9, 10 and 14, upper member 40′ is bell-shaped with a rounded front edge 42′. Again, however, upper member 40′ may comprise a wide variety of shapes, as discussed above.

Lower member 60′ is substantially U-shaped, having two legs 62′ and 64′. The first leg 62′ extends in a serpentine pattern downward and frontwardly from primary member 20′, again, frontwardly meaning in the same direction from the major plane of primary member 20′ that upper member 40′ extends, or more plainly, towards the table about which the skirting is being secured.

Leg 64′ is preferably a substantially vertical member extending upward toward upper member 40′. In this embodiment, leg 62′ preferably includes a first bend 76. An upper end 66′ of leg 64′ of lower member 60′ is spaced a distance below upper member 40′. In use, retainer 10′ is attached to the edge of a table top (not shown) by engaging the upper surface of the table top with upper member 40′ and the lower surface of the table top with lower member 60′. More particularly, the upper surface of the table top engages the lower surface 44′ of upper member 40′, and the lower surface of the table top engages upper end 66′ of leg 64′.

The lower surface of the table top engages portion 68′, as follows: Upper end 66′ of leg 64′ preferably includes a camming portion 68′ to more easily engage the lower surface of a table top. In this embodiment, as shown in FIGS. 9, 10 and 13, portion 68′ is a substantially planar portion 70 including a top surface 72 that may have an outward curve 74. Again, portion 68′ is not limited to having a curved surface, but may comprise any shape and size that aids in engaging the lower surface of a table top. As shown in FIG. 13, portion 68′ of upper end 66′ is generally positioned directly beneath front edge 42′ of upper member 40′. Preferably, curve 74 is directly below the middle of the bottom surface 44′ of upper member 40′. This allows for engagement of a flat surface, such as a table top, by curve 74 and surface 44′. These two points on the retainer members are in a substantially vertical axis, and prevent disengagement of the retainer due to slippage. In addition, preferably, an engagement surface 43′ on upper member 40′ is positioned directly above an engagement surface 65′ on lower member 60′.

Upper end 66′ of lower member 60′ is spaced a distance below upper member 40′, thereby defining a predetermined spacing d₁ between the upper and lower members 40′, and 60′, respectively. As with the previous embodiment, this distance d₁' determines the particular table top to which a retainer may be secured. In the embodiment shown in FIGS. 6 through 15, the distance d₁ is preferably about ¾ inch and, thus, this retainer may be secured to those tables having a table top with a height of about ¾ inch.

As shown most clearly in FIGS. 9, 10 and 13, in this embodiment, legs 62′ and 64′ of lower member 60′ are substantially the same length when measuring leg 62′ from lower end 24′ of primary member 20′ to the juncture 63′ of legs 62′, 64′ and measuring leg 64′ from juncture 63′ of legs 62′, 64′ to the substantially planar portion 70′. In particular, legs 62′, 64′ may be about 13 mm to about 30 mm in length. In one embodiment, legs 62′, 64′ are about 22 mm in length.

As with the previous embodiment, leg 62′ of retainer 10′ is relatively long in comparison to conventional retainers. Also, primary member 20′ is preferably shorter in height (i.e., from lower end 24′ to upper end 22′) than conventional retainers. In addition, the flexibility of retainer 10′ of the present invention is enhanced because of the presence of slots 30′ and 32′ in primary member 20′. In particular, slots 30′ and 32′ define finger 31′ and finger 33′ of primary member 20. Slots 30′ and 32′ are continuous from the interior of primary member 20′ to the lower edge of primary member 20′ so as to define the side edges of leg 62.′ Fingers 31′ and 33′ generally correspond to hook areas 88′ and 84'. Fingers 31′ and 33′ are useful because they enable primary member 20′ to have a larger surface area, due to the inclusion of hook areas 88′ and 84′, while providing retainer 20′ with the same flexibility that a retainer would have if fingers 31′ and 33′ were severed at their upper end and removed.

Moreover, as shown most clearly in FIGS. 9, 10 and 13, leg 62′ slants in the direction toward the table when engagement surface 65′ is biased, as retainer 10′ is secured to a table edge. The presence of bend 76 in leg 62′ is preferred to ensure the structural integrity of lower member 60′ and to allow retainer 10′ to flex more readily. As discussed above, because leg 62′ slants towards the table when retainer 10′ is secured to a table, a table skirt attached to a plurality of retainers 10′ may lay flat in the downward direction, and will generally not lay at a slant outward from the table, as may occur with conventional retainers, as discussed above.

The flexibility of lower member 60′ is enhanced because of three radius portions present in S-shaped lower member 60′. The first, radius portion 77′ is formed at the juncture of lower member 60′ and primary member 20′. The second radius portion, bend 76, essentially serves as a fulcrum point for retainer 10′. The third radius portion is at the bottom of the U-shaped lower member—i.e., at juncture 63′.

It is preferred that the retainer of the second embodiment also be fabricated using an extrudable plastic material such as polyolefin, polycarbonate, nylon, or the like. In addition, in both of the embodiments described above, the parts of the retainers are preferably made from a transparent plastic so that they can be discerned only upon close inspection. Such retainers thus do not draw attention away from the table skirt held in place around the edge of a table top. Preferably, polyolefin is used because of its flexibility and its transparent-like qualities. The hooks are preferably extruded from the same material as the primary member and are integral with the primary member. This avoids the time and cost of attaching a separate strip of material containing hooks to the back surface of the primary member. In the alternative, however, separate strips of hook-containing material may be used with this invention by attaching the separate strips, e.g., by adhesive, to the back surface of the primary member.

In both embodiments described above, the retainer may be attached to the edge of a table top by engaging the upper surface of the table top with the upper member and the lower surface of the table top with the lower member. Preferably, a plurality of retainers are first placed at intervals around the edge of one or more sides of the periphery of the table top such that the hook portion faces outward. For releasable engagement of the hook portion, the loop portion (not shown) is attached to the periphery of the table skirt (not shown) and includes a plurality of loops. To hang a table skirt from the table top, the table skirt is pressed against the individual retainers around one or more sides of the table. The table skirt is pressed against the individual retainers while aligning the loop portions of the table skirt to the hooking portions of the retainers. Pressing the loop portions of the table skirt against the hooking portions of the retainers allows the hooks and loops to engage and form mechanical bonds. Once it is desired to remove the table skirt, the mechanical bonds between the hooks on the retainers and the loops on the table skirt may be broken by peeling the loops from the hooks.

It will be apparent to those skilled in the art that various modifications and variations can be made in the method of the present invention without departing from the spirit or scope of the invention. Thus, it is intended that the present invention cover the modifications and variations of this invention provided that they come within the scope of the appended claims and their equivalents.

We claim:

1. A retainer to secure fabric to an edge of a planar member, comprising:
a primary member having an upper end, a lower end, a front surface and a back surface;
an upper member contiguous with, and extending frontwardly from, the upper end; and
a lower member contiguous with, and extending frontwardly from, the lower end.

2. The retainer according to claim 1, wherein the retainer is attachable to an edge of a table top by engaging an upper surface of the table top with the upper member, and by engaging a lower surface of the table top with the lower member.

3. The retainer according to claim 1, wherein said lower member maintains a first leg connected to the primary member and a second leg connected to the first leg, the first leg slanting linearly downwardly and frontwardly.

4. The retainer according to claim 1, wherein the distance between the upper member and an engagement surface of the lower member is between about ¾ inch and about ⅜ inch.

5. The retainer according to claim 1, wherein an engagement surface of the lower member is positioned directly beneath the upper member.

6. The retainer according to claim 1, wherein an engagement surface of the lower member is positioned in a substantially vertical axis with an engagement surface of the upper member.

7. The retainer according to claim 1, wherein the upper member is bell shaped.

8. The retainer according to claim 1, wherein the retainer is made substantially from a transparent plastic material.

9. The retainer according to claim 1, wherein said material is polyolefin, polycarbonate, nylon or combinations thereof.

10. The retainer according to claim 3, wherein the lower member is substantially U-shaped, the first leg being about the same length as the second leg.

11. The retainer according to claim 10, wherein the first leg extends downward a distance in the range of about 13 mm to about 30 mm.

12. A retainer to secure fabric to an edge of a planar member, comprising:
a primary member having an upper end, a lower end, a front surface and a back surface;
a frontwardly extending upper member contiguous with the upper end of the primary member; and
a lower member having a frontwardly extending, serpentine-shaped first leg connected to the lower end, and a second leg connected to the first leg.

13. The retainer according to claim 12, wherein the retainer is attachable to the edge of a table top by engaging an upper surface of the table top with the upper member, and by engaging a lower surface of the table top with the lower member.

14. The retainer according to claim 12, wherein the lower member is substantially U-shaped, the first leg being essentially the same length as the second leg.

15. A retainer to secure fabric to an edge of a substantially planar member, comprising:
a primary member having an upper end, a lower end, a front surface, a back surface, and at least one continuous slot formed through the lower end, said slot defining at least one finger;
an upper member extending from the upper end of the front surface; and
a lower member extending from the lower end of the primary member, said lower member having a first leg connected to the primary member, and a second leg connected to the first leg.

16. The retainer according to claim 15, wherein the retainer is attachable to the edge of a table top by engaging an upper surface of the table top with the upper member, and by engaging a lower surface of the table top with the lower member.

17. The retainer according to claim 15, wherein said at least one is a plurality of at least two said slots, corresponding to at least two said fingers.

18. The retainer according to claim 17, wherein the distance between said slots defines the width of the lower member.

19. The retainer according to claim 17, wherein the back surface of the primary member comprises a hook portion of a hook and loop type fastener.

20. The retainer according to claim 19, wherein said hook portion is extruded.

21. The retainer according to claim 19, wherein said hook portion is attached.

22. The retainer according to claim 19, wherein said hook portion comprises a plurality of separate hook areas.

23. The retainer according to claim 19, wherein said first leg extends linearly downwardly and frontwardly.

24. The retainer according to claim 19, wherein said first leg is of serpentine-shape, extending downward and frontwardly.

25. The retainer according to claim 22, wherein one of said hook areas is disposed upon the back surface of each of said fingers.

26. The retainer according to claim 25, wherein one of said hook areas is disposed upon the back surface of the primary member, between said fingers.

27. A retainer to secure skirting to an edge of a table top, comprising:
a primary member having an upper end, a lower end, a front surface, a back surface, and two continuous slots formed through the lower end so as to define two outside fingers having a distance therebetween that is equivalent to or slightly greater than the width of the lower member, wherein the back surface of the primary member comprises a hook portion of a hook and loop type fastener, said hook portion comprising a separate hook area for each of said fingers;
an upper member extending frontwardly from the front surface of the upper end; and
a lower member extending from the lower end of the primary member, said lower member having a frontwardly and downwardly slanting first leg connected to the lower end of the primary member, and a second leg connected to the first leg.

28. A retainer to secure skirting to an edge of a table top, comprising:
a primary member having an upper end, a lower end, a front surface, a back surface, and two continuous slots formed through the lower end so as to define two outside fingers having a distance therebetween that is equivalent to or slightly greater than the width of the lower member, wherein the back surface of the primary member comprises a hook portion of a hook and loop type fastener, said hook portion comprising a separate hook area for each of said fingers;
an upper member extending frontwardly from the front surface of the upper end; and
a lower member extending from the lower end of the primary member, said lower member having a serpentine-shaped, frontwardly extending first leg connected to the lower end of the primary member, and a second leg connected to the first leg.

29. A method of securing skirting to an edge of a table top, comprising the steps of:
providing a plurality of retainers, each retainer comprising:
a primary member having an upper end, a lower end, a front surface facing frontwardly, a back surface opposite the front surface, and a hook portion of a hook and loop type fastener formed on the back surface;
a frontwardly extending upper member;
a substantially U-shaped lower member having a first leg extending frontwardly from the lower end, and a second leg extending from the first leg;
attaching the plurality of retainers to the edge of a table top by engaging an upper surface of the table top with the upper member, and by engaging a lower surface of the table top with the lower member; and
engaging a loop portion of a table skirt with the hook portion of the primary member.

30. The retainer according to claim 29, wherein said first leg slants linearly downward.

31. The retainer according to claim 29, wherein said first leg maintains a serpentine curve.

32. The method according to claim 29, wherein the primary member maintains a plurality of continuous vertical slots defining fingers, said slots and said fingers extending to the lower end of the primary member.

33. The retainer according to claim 32, wherein said hook portion comprises a separate hook area for each of said fingers.

34. The retainer of claim 32, wherein said plurality is two, said slots maintaining a distance from each other roughly equivalent to the width of said lower member.
